(19) United States
(12) Patent Application Publication
(10) Pub. No.: US 2006/0067162 A1
(43) Pub. Date: Mar. 30, 2006

(54) Ultrasonic cement scanner

(76) Inventors: Thomas J. Blankinship, Fort Worth, TX (US); Edwin K. Roberts, Fort Worth, TX (US); Lucio N. Tello, Benbrook, TX (US)

Correspondence Address: WEATHERFORD INTERNATIONAL LTD. C/O;PAT MCCOLLUM, 515 POST OAK BLVD., SUITE 600, HOUSTON, TX, 77027, US

(21) Appl. No.: 10/954,124

(22) Filed: Sep. 29, 2004

(51) Int. Cl. G01V 1/40

(52) U.S. Cl. 367/35

(57) ABSTRACT

An acoustic borehole logging system for parameters of a well borehole environs. Full wave acoustic response of a scanning transducer is used to measure parameters indicative of condition of a tubular lining the well borehole, the bonding of the tubular to material filling an annulus formed by the outside surface of the tubular and the wall of the borehole, the distribution of the material filling the annulus, and thickness of the tubular. A reference transducer is used to correct measured parameters for variations in acoustic impedance of fluid filling the borehole, and for systematic variations in the response of the scanning transducer. Corrections are made in real time. The downhole tool portion of the logging system is operated essentially centralized in the borehole using a centralizer that can be adjusted for operation in a wide range of borehole sizes.

This invention is directed toward a borehole logging system for the measure of properties and conditions of a well borehole environs. More particularly, the invention is directed toward an acoustic logging system for measuring and mapping physical condition of a tubular lining the well borehole, the bonding of the tubular to material filling an annulus formed by the outside surface of the tubular and the wall of the borehole, and the distribution of the material within the annulus.

### BACKGROUND OF THE INVENTION

Well boreholes are typically drilled in earth formations to produce fluids from one or more of the penetrated formations. The fluids include water, and hydrocarbons such as oil and gas. Well boreholes are also drilled in earth formations to dispose waste fluids in selected formations penetrated by the borehole. The boreholes are typically lined with tubular commonly referred to as casing. Casing is typically steel, although other metals and composites such as fiberglass can be used. The outer surface of the casing and the borehole wall form an annulus, which is typically filled with a grouting material such as cement. The casing and cement sheath perform several functions. One function is to provide mechanical support for the borehole and thereby prevent the borehole from collapsing. Another function is to provide hydraulic isolation between formations penetrated by the borehole. The casing can also be used for other functions such as means for conveying borehole valves, packers, pumps, monitoring equipment and the like.

The wall of the casing can be thinned. Corrosion can occur both inside and outside of the casing. Mechanical wear from pump rods and the like can wear the casing from within. Any type of casing wear can affect the casing's ability to provide mechanical strength for the borehole.

Grouting material such as cement filling the casing-borehole annulus hydraulically isolates various formations penetrated by the borehole and casing. If the cement is not properly bonded to the outer surface of the casing, hydraulic isolation is compromised. If the cement does not completely fill the casing-cement annulus, hydraulic isolation is also compromised. Furthermore, if casing corrosion occurs on the outer surface or within, or if wear develops within the casing, holes can form in the casing and hydraulic isolation can once again be compromised.

In view of the brief discussion above, it is apparent that measures of casing wear, casing corrosion, cement bonding and cement distribution behind the casing can be important from economic, operation and safety aspects. These measures will be subsequently referred to as borehole “parameters of interest”.

Measures of one or more of the borehole parameters of interest are useful over the life of the borehole, extending from the time that the borehole is drilled until the time of abandonment. It is therefore economically and operationally desirable to operate equipment for measuring the borehole parameters of interest using a variety of borehole survey or “logging” systems. Such logging systems can comprise multiconductor logging cable, single conductor logging cable, and production tubing.

Borehole environments are typically harsh in temperature, pressure and ruggosity, and can adversely affect the response of any logging system operating therein. More specifically, measures of the borehole parameters of interest can be adversely affected by harsh borehole conditions. Since changes in borehole temperature and pressure are typically not predictable, continuous, real time system calibration within the borehole is highly desirable.

It is advantageous economically and operationally to obtain measures of parameters of interest in real-time. Real-time measurements can detect and quantify borehole problems, remedial action can be taken, and the measurements can be repeated to evaluate the action without the cost and loss of time involved in removing and repositioning a logging system. This is particularly important in offshore operations.

Boreholes are drilled and cased over a wide range of diameters. Casing inside diameter can also vary due to corrosion and wear. It is therefore desirable for a borehole measurement system to operate over a range of borehole diameters, with the necessity to change physical system elements minimized.

### SUMMARY OF THE INVENTION

This present invention is directed toward an acoustic logging system that measures casing inside diameter, casing thickness which can be an indication of casing corrosion, the condition of the cement within the casing-cement annulus, and casing-cement bonding. These parameters are preferably displayed as two dimensional images or “maps”. The image of each parameter of interest preferably encompasses a full azimuthal sweep of the borehole, and is displayed as a function of depth within the borehole thereby forming a two dimensional “log” of each parameter. The borehole assembly of the system utilizes at least one acoustic transducer with a known frequency response and mounted on a rotating scanning head that is pointed essentially perpendicular to the borehole wall. The transducer generates a sequence of acoustic energy bursts as the scanning head is rotated. A response signal, resulting from the energy bursts interacting with borehole environs, is measured and recorded. These signals and the responses of a reference transducer system are then analyzed and combined, using predetermined relationships, to determine parameters of interest including acoustic impedance of cement behind casing, casing thickness, casing inside diameter and casing-cement bonding. These parameters are preferably presented as 360 degree images of the borehole as a function of depth. Casing corrosion and wear patterns can be determined from the casing thickness and casing diameter measurements. The measurement system will hereafter be referred to as the Ultrasonic Cement Scanner logging system

Parameters of interest can be computed within the borehole assembly and telemetered to the surface thereby minimizing telemetry band width requirements. The system is operable in fluid filled uncased as well as fluid filled cased boreholes.

### BRIEF DESCRIPTION OF THE DRAWINGS

So that the manner in which the above recited features, advantages and objects the present invention are obtained and can be understood in detail, more particular description of the invention, briefly summarized above, may be had by reference to the embodiments thereof which are illustrated in the appended drawings.

FIG. 1 illustrates the major elements of the Ultrasonic Cement Scanner logging system operating in a well borehole environment;

FIG. 2 is a detailed view of a scanning transducer assembly disposed within the scanning head;

FIG. 3 illustrates a centralizer subassembly;

FIG. 4 illustrates the major elements of a mechanical subassembly;

FIG. 5 illustrates a cross sectional view of the reference transducer assembly;

FIG. 6 is a function diagram of the major elements of an electronics subassembly;

FIG. 7 illustrates a typical acoustic waveform measured by the scanning or the monitor transducer;

FIG. 8 depicts a curve reflecting intensity of scanning transducer response as a function of frequency in a defined time region of the full wave response shown in FIG. 7; and

FIG. 9 is a flow chart of data processing methodology used to generate azimuthal maps as a function of depth of one or more parameters of interest.

### DETAILED DESCRIPTION OF THE PREFERRED EMBODIMENTS

Overview of the System

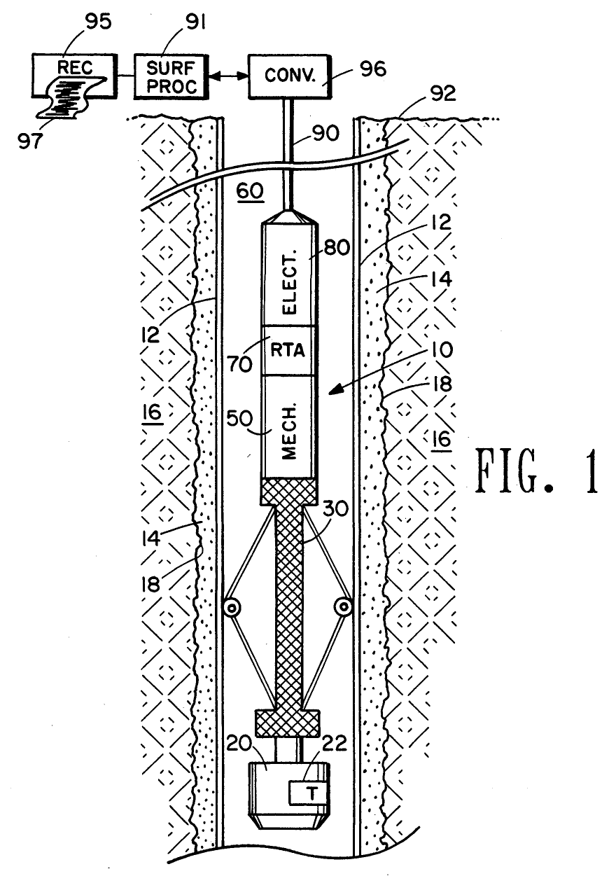

FIG. 1 illustrates the major elements of the Ultrasonic Cement Scanner logging system operating in a well borehole environment. The downhole apparatus or “tool”, identified as a whole by the numeral 10, is suspended at a down hole end of a data conduit 90 in a well borehole defined by walls 18 and penetrating earth formation 16. The borehole is cased with a tubular casing 12, and the annulus defined by the borehole wall 18 and the outer surface of the casing 12 is filled with a grout 14 such as cement. The casing is filled with a fluid 60.

Again referring to FIG. 1, the lower end of the tool 10 is terminated by a scanning head 20 comprising an ultrasonic scanning transducer 22 of known frequency response. The scanning head is rotated about the major axis of the tool 10, and the scanning transducer 22 is activated or “fired” in sequential bursts as the scanning head 20 is rotated. The scanning transducer 22 is disposed such that emitted acoustic energy bursts are directed essentially perpendicular to the major axis of the borehole. The transducer is fired at azimuthal positions, which are preferably sequentially at equal time intervals and burst widths, about 72 times per revolution of the scanning head 20. A response signal, resulting from each emitted acoustic energy burst interacting with the borehole environs, is measured by the scanning transducer 22 and subsequently processed. Only one transducer is illustrated, but it should be understood that two or more transducers can be disposed within the scanning head 20, and responses of each scanning transducer processed to obtain parameters of interest. The scanning head 20 is easily interchanged so that the diameter of the scanning head can be selected to yield maximum response in a borehole of given diameter. Characteristics of the scanning transducer, signal properties, and signal processing will be discussed in detail in subsequent sections of this disclosure.

Still referring to FIG. 1, the scanning head 20 is operationally attached to a centralizer subassembly 30, which positions the tool 10 essentially in the center of the borehole.

The centralizer subassembly 30 is operationally attached to a mechanical subassembly 50 as is illustrated in FIG. 1. The mechanical sub section comprises a motor which rotates the scanning head 20, a slip ring assembly to conduct electrical signals to and from the scanning transducer 22 within the scanning head 20, and a pressure balance system that is used to maintain certain elements of the tool 10 at borehole pressure.

A reference transducer assembly 70 is disposed above the mechanical subassembly 50 as illustrated in FIG. 1. The reference transducer assembly measures the slowness and the acoustic impedance of the borehole fluid 60. The reference transducer assembly is also responsive to systematic variations in the response of the tool 10, such as transducer drift, temperature related changes in electronic components, and the like. These measurements are used to correct measured parameters of interests for changes in the scanning transducer response due to environmental or systematic operational conditions.

Again referring to FIG. 1, the upper end of the tool 10 is terminated with an electronics subassembly 80. The electronics subassembly comprises electronics for controlling the various elements of the tool 10, a control processor 86 which directs the operation of the tool, a data processor 84 which processes full wave signals from the scanning 22 and reference 70 transducers to obtain one or more parameters of interest, power supplies 88 to operate electrical elements of the tool 10, and a down hole telemetry element for transmitting data to and receiving data from the surface of the earth.

Details of the centralizer subassembly 30, the mechanical subassembly 50, the reference transducer assembly 20, and the electronics subassembly 80 are presented in subsequent sections of this disclosure.

The tool 10 is shown suspended within the casing 12 by the data conduit 90 that is operationally attached at an up hole end to a conveyance means 96 at the surface of the earth 92. The Ultrasonic Cement Scanner can be embodied in a variety of configurations. As examples, if the data conduit 90 is a multi conductor wireline, the conveyance means 96 is a logging system draw works as is known in the art. If the data conduit 90 is a single conductor cable, the conveyance means 96 is again a logging system draw works but typically smaller in size. If the data conduit 90 is a coiled tubing with one or more conductors therein, then the conveyance means is a coiled tubing injector as is known in the art. A surface processor 91 is used for data processing at the surface, and is shown operationally connected to the conveyance means 96. A recording means 95 cooperates with the surface processor 91 to generate one or more “logs” 97 of parameters of interest measured as a function depth of the tool 10 within the borehole. For purposes of further discussion, it will be assumed that the data conduit is a wireline cable comprising one or more conductors, and the conveyance means 96 is a logging system draw works comprising a motor, a winch, and tool depth measuring apparatus.

The Scanning Transducer Assembly

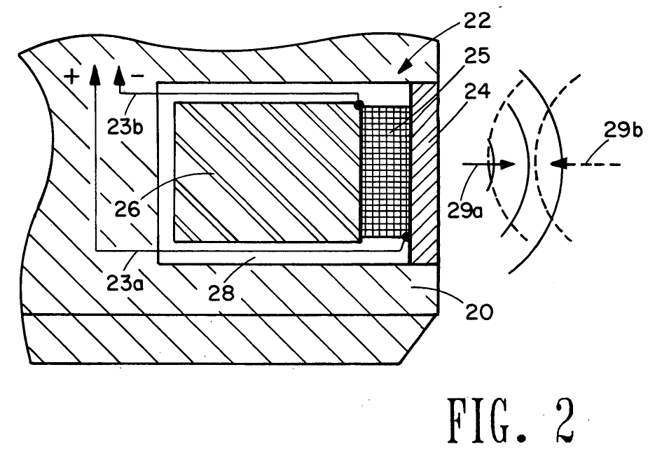

FIG. 2 is a detailed view of the scanning transducer 22 disposed within the scanning head 20. Only one transducer assembly is illustrated, but it should be understood that two or more transducer assemblies can be disposed within the scanning head. The transducer assembly comprises preferably a piezoelectric crystal 25 operating in the 450 kilo Hertz (kHz) range. One face of the crystal is covered with a window 24 with a thickness of a quarter wavelength. A second face of the crystal is attached to a backing material 26. The backing material 26 is a composite comprising a large density material, such as tungsten, evenly dispersed in an elastic material, such as rubber. The composite density is in the range of 10 grams per cubic centimeter (gm/cm³) to 19 gm/cm³. The composite mixture is fabricated to match the acoustic impedance of the backing material with the acoustic impedance of the crystal. Matching these acoustic impedances directs bursts of acoustic energy from the scanning transducer 22 essentially perpendicularly into the borehole wall (not shown) as illustrated by the solid waves and arrow 29a. The crystal 25 and backing material 26 are encapsulated in a material 28, such as epoxy, and the transducer 22 is received in the scanning head 20. Opposing sides of the crystal 25 are biased positive and negative, as illustrated with the leads 23a and 23b, respectively. A potential difference is sequentially applied across the crystal as the scanning head rotates, thereby emitting the bursts of energy circumferentially around the borehole. A portion of the energy from each burst interacts with the borehole environs, and returns to the rotating transducer assembly as illustrated conceptually with the broken line waves and arrow 29b. The response of the crystal is transmitted via the leads 23a and 23b for processing, as will be subsequently discussed. Rotation or “stepping” of the scanning head, firing of the transducer, and reception of the return signal are controlled by elements in the electronics subassembly 80 and the mechanical subassembly 50. These functions are timed so that data obtained FROM THE firing-reception cycle are independent of prior and subsequent firing-reception cycles thereby optimizing accuracy and precision of measured parameters of interest. The scanning transducer is preferably fired 72 times per revolution of the scanning head 20, and the scanning head is rotated preferably six times per second.

As mentioned previously, only one transducer 22 is illustrated in FIG. 2, but it should be understood that two or more transducer assemblies can be disposed within the scanning head 20.

The Centralizer Subassembly

The Ultrasonic Cement Scanner logging system is designed to be run centralized within the borehole. The centralizer subassembly 30 provides sufficient forces to centralize the tool 10 in highly deviated boreholes, but does not provide excessive force which would hinder conveyance of the tool along the borehole. To meet these criteria, the centralizer subassembly 30 is set for nominal borehole conditions preferably prior to logging. As an example, since the tool 10 is typically operated in a cased borehole, the centralizer subassembly 30 is configured for a specific nominal casing inside diameter.

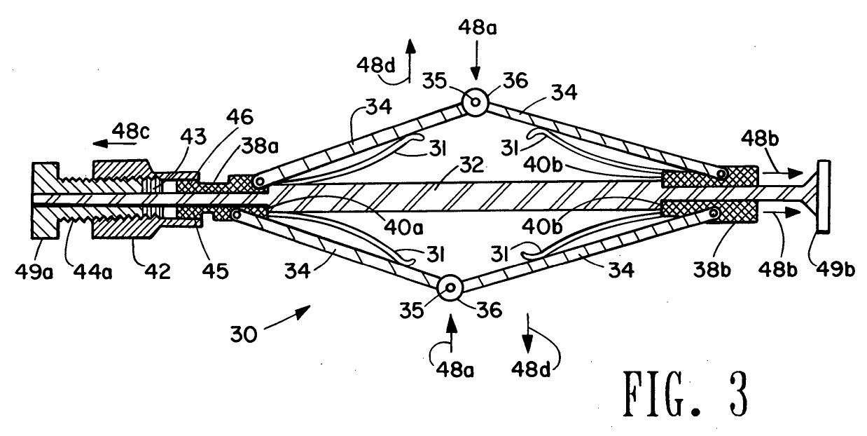

A cross sectional view of the centralizer subassembly 30 is shown in FIG. 3. The centralizer subassembly 30 comprises a preferably cylindrical mandrel 30 that is terminated by connector assemblies 49a and 49b. These connectors operationally connect the centralized subassembly 30 to subassemblies above and below. The mandrel 30 is preferably fabricated with a conduit there through to allow passage of wiring from the tool subassemblies on either side of the centralizer subassembly. As illustrated, the left side of the mandrel 32 is reduced in diameter thereby forming a shoulder 40a. Likewise, the right side of the mandrel is reduced in diameter forming a shoulder 40b. Slider assemblies 38a and 38b are disposed on the left and right side reduced diameter sections of the mandrel 32, respectively, and are sized so that they can slide thereon.

Still referring to FIG. 3, “mandrel” ends of centralizer arms 34 are attached pivotally to the slider assemblies 38a and 38b. Opposing ends of the centralizer arms 34, referred to as the “roller” ends, are pivotally attached at a roller 36 and cooperating axle 35. Preferably leaf type springs 31 are affixed at one end to the either slider assembly 38a or 38b. Opposing ends of the springs 31 contact, but are not affixed to, the centralizer arms 34 to urge the rollers 36 outward as illustrated conceptually by the arrows 48d. A minimum of three sets of centralizer arm and roller assemblies. or “centralizer arm sets”, are disposed circumferentially around the mandrel 32. Preferably, six centralizer arm sets are disposed at equal azimuthal angles around the circumference of the mandrel 32. The mandrel ends of the assembly arms are axially displaced so that the plurality of centralizer arm sets can be collapsed within a diameter defined by the diameters of the connectors 49a and 49b.

As mentioned previously, the centralizer assembly 30 is used to position the tool 10 essentially at the center of the borehole, which is typically cased. The centralizer subassembly is typically set up for a nominal casing inside diameter so that the spring force, represented conceptually by the arrows 48d in FIG. 3, will support the weight of the tool 10 at any borehole angle encountered. By not using excessive force beyond that required to centralize the tool 10, and by using the rollers 36 to contact the inside of the borehole, friction is minimized as the tool is conveyed along the borehole. The nominal inside diameter of the casing can vary due to material build-up, corrosion, wear and the like. The centralizer subassembly adjusts for these variations in nominal diameter. Adjustments can be made over this “operating range” without permanently deforming the springs 31. The slider assembly 38a is held fixed with respect to the mandrel assembly 32 by an adjustment nut 42, as will be discussed subsequently. If the inside of the casing constricts, a force illustrated conceptually by the arrows 48a “compress” the centralizer arm assemblies thereby moving the slider assembly 38b to the right, as illustrated conceptually by the arrow 48b. If the inside diameter of the casing increases, the slider assembly 38b moves to the left under the influence of the springs 31. These actions keep the rollers 36 in contact with the borehole wall thereby providing the desired tool centralization.

The inside diameter of the casing can increase sufficiently so that one or more rollers 36 fail to contact the borehole wall. When this occurs, tool centralization is lost. This occurs when the slider assembly 38b moves to the left and abuts the shoulder in the mandrel identified at 40b. Stated another way, the borehole diameter has exceeded the set operating range of the centralizer subassembly. Such a situation is shown in FIG. 3, and might occur if the tool enters a string of casing with a significantly larger nominal inside diameter. Under these conditions, the centralizer assembly 30 must be adjusted to another operating range for operation in a casing of different nominal dimensions. This adjustment is obtained using the adjustment nut 42, which surrounds the mandrel 32. As shown in FIG. 3, the right end of the adjustment nut 42 is terminated with an inside shoulder 46. An outside shoulder 45 of the slider assembly 38a is held in contact with the shoulder 46 by the action of the springs 31. The left end of the adjustment nut 42 comprises a female thread 43 that receives a male thread structure 44a terminated on the left by the connector assembly 49a. The male thread structure 44a is affixed to the mandrel 32. The centralizer subassembly 30 is set for operation in a nominal borehole diameter by rotating the adjustment nut 42. As an example, if the adjustment nut is rotated so that it moves to the left (as illustrated conceptually by the arrow 48c), the centralizer arm assembly is compressed. This permits the centralizer subassembly 30 to be operated effectively at a smaller operating range in a borehole with a smaller nominal diameter, without permanently deforming the springs 31. Conversely, if the adjustment nut 42 is rotated so that it moves to the right, the centralizer arm assembly is expanded thereby permitting the centralizer subassembly 30 to be operated effectively at a larger operating range in a borehole with a larger nominal diameter.

To summarize, the centralizer subassembly 30 can be adjusted for operation in boreholes spanning a large range of nominal diameters by setting the adjustment nut 42 accordingly. No mechanical parts need to be changed. No excessive force is exerted on, or by, the springs and cooperating centralizer arms thereby optimizing the mechanical life of the subassembly, providing sufficient force for proper tool centralization, and minimizing friction as the tool 10 is conveyed within the borehole.

The Mechanical Subassembly

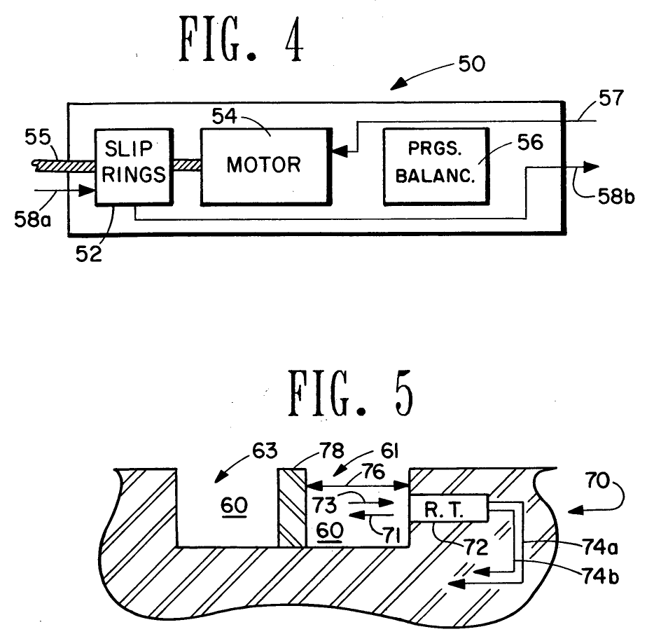

FIG. 4 illustrates the major elements of the mechanical subassembly 50 in the form of a functional diagram. A motor 54 rotates the scanning head 20 (see FIGS. 1 and 2) through a shaft 55. Control signals and power for the motor are supplied via a group of leads 57, which terminate in the electronics subassembly 80. Signals from the one or more transducers 22, represented conceptually by the arrow 58a, are passed through a slip ring assembly 52 and subsequently sent via leads 58b to the electronics subassembly 80 for processing. As stated above, the operation of the motor 54 and firing of the scanning transducer 22 are such that each firing-reception cycle is independent of other firing-reception cycles.

The Reference Transducer Assembly

As in most borehole survey systems, the Ultrasonic Cement Scanner logging system is calibrated at the surface of the earth prior to operation within the borehole. Also, as in most borehole survey systems, the environment within the borehole and systematic variations in elements of the tool during operation can cause the tool to deviate from initial calibration. This deviation typically results in erroneous measures of the parameters of interest. The primary function of the reference transducer assembly 70 is to measure or monitor, in real time, certain parameters that can change while logging and that can affect the accuracy and precision of computed parameters of interest. Stated another way, the reference transducer monitors and provides data for correction of tool calibration during logging. Subsequent sections of this disclosure will address system calibration, measured data, and the processing of these data to obtain parameters of interest. Adverse effects of environmental and equipment changes are minimized using measurements obtained from the reference transducer assembly 70. This section discloses the physical elements of the reference transducer assembly 70, and illustrates the basic response of the assembly. The use of these responses in correcting scanning transducer data will become more apparent in subsequent sections.

Referring again to FIG. 1, borehole fluids 60 typically have different acoustic properties as a function of depth within a well borehole. As an example, near the bottom of the well, the borehole fluid tends to be denser than at the top due to settlement of solids within the borehole fluid. Moving up the borehole, heavy drill fluids settle at the bottom of the borehole fluid column followed by lighter fluids from penetrated formations and other sources. Finally, any borehole oil rises to the top of the fluid column. Changes in the acoustic impedance of the borehole fluid drastically influence the response of the tool 10 to the acoustic impedance of the grouting material 14, and the ability of the logging system to measure the correct acoustic impedance of the material behind casing 12. There is, therefore, a need to measure the acoustic impedance of the borehole fluid 60 in real time so the proper measurement of the cement acoustic impedance can be rendered.

FIG. 5 illustrates a cross sectional view of the reference transducer assembly 70. A reference transducer 72 is disposed within the reference transducer assembly 70 so that preferentially sequential bursts of acoustic energy are emitted into a first chamber 61 in a direction conceptually illustrated with the arrow 71. The chamber 61 is filled with borehole fluid 60. A portion of each emitted burst of acoustic energy is reflected by a plate 78 disposed a distance 76 from the face of the reference transducer 72. This reflected energy is illustrated conceptually with the broken arrow 73. The face of the plate 78 is essentially parallel to the emitting face of the reference transducer 72, and perpendicular to the major axis of the tool 10. Travel time of the acoustic energy to and from the references transducer is measured. Since the distance is 76 is known, this measure of travel time can be used to measure and monitor any changes the slowness and the acoustic impedance of the borehole fluid 60.

A second chamber 63 is disposed in the reference transducer assembly 70 as shown in FIG. 5. The second chamber is also filled with borehole fluid 60, and is dimensioned so that ring down of each acoustic energy pulse can be measured by the reference transducer without interference from material in the tool 10. Stated another way, the second chamber 63 allows “free pipe” values to me measured while the tool 10 is logging the borehole.

Power is supplied to the reference transducer 72, and responses of the reference transducer are transmitted via the leads 74a and 74b as will be discussed in a subsequent section of this disclosure.

Measures of borehole fluid acoustic impedance and free pipe parameters are used to correct measured parameters of interests for changes in the scanning transducer response due to environmental or operational conditions. These corrections will be discussed in detail in a subsequent section of this disclosure.

Electronics Subassembly

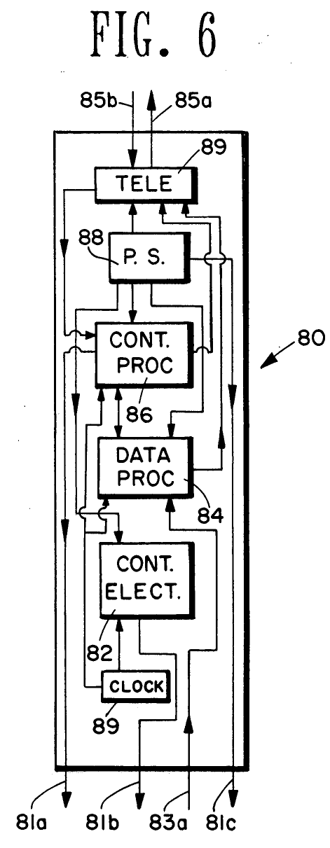

FIG. 6 is a function diagram of the major elements of the electronics subassembly 80. Overall operation of the tool 10 is performed by electrical signals from a control electronics element 82 cooperating with a clock 89. Tool operation signals include, but are not limited to, electrical signals for pulsing the scanning transducer 22 and recording data at predetermined time intervals, and electrical signals for pulsing of the reference transducer 72 and the recording of data at predetermined time intervals. These electrical signals are supplied via leads represented as a group at 81b.

Again referring to FIG. 6, the control electronics element 82 functions under commands from a control processor 86. The control processor 86 is programmed with magnitudes of tool operating parameters such scanning and reference transducer pulse rates, azimuthal positions at which the scanning transducer is fired, pulse widths, and data collection time intervals. As an example, the control processor transmits a signal to the motor 54 in the mechanical subassembly 50 to rotationally “step” the scanning head 20 to preferably sequential azimuthal positions. The control processor 86 also transmits a signal to initiate the firing the scanning transducer 22. These functions are timed so that data obtained firing-reception cycle are independent of prior and subsequent firing-reception cycles thereby optimizing accuracy and precision of measured parameters of interest. Control signals are supplied to these previously discussed elements, and to other elements, via the leads represented as a group at 81a. This stepping-firing method optimizes azimuthal resolution of the tool response by permitting an optimum number of azimuthal positions of firing per scanning head revolution wherein the processed data are free of interference for prior and subsequent firings.

Still referring to FIG. 6, response data from the scanning transducer 22 and the reference transducer 84 are input into a data processor 84. One or more parameters of interest are computed from these response data using subsequently discussed methodology. Stated another way, the operation of the tool 10 is under the control of the control processor 86, and the processing of data is under control of the data processor 84. A power supply element 88 supplies power to the control processor 86, the data processor 84, the control electronics element 82, and a down hole telemetry element 89. The power supply element 88 also provides power to the scanning transducer 22, the reference transducer 72, and the motor 54 via the leads shown collectively as 81c. Separate processors are used for convenience of programming. It should be understood, however, that both the functions of processors 84 and 86 could be performed by a single processor. It should also be understood that elements of the electronics subassembly 80 can be configured differently while still achieving the same functional performance.

Again referring to FIG. 6, the down hole telemetry element 89 provides two way communication preferably with an up hole telemetry element the surface processor 91 over the conduit 91 (see FIG. 1). Data from the scanning and reference transducers 22 and 72, respectfully, are transmitted to the surface of the earth 92 as illustrated conceptually by the arrow 85a. In addition, command signals related to the operation of the tool can be sent from the up hole telemetry element at the surface 92 to the tool 10 via the down hole telemetry element 89, as illustrated conceptually with the arrow 85b.

Basic Transducer Response

Full acoustic waveforms are recorded from both the scanning transducer 22 and the reference transducer 72. The analog waveform responses of the transducers are preferably digitized in the data processor 84.

FIG. 7 illustrates a typical waveform, which is a plot of transducer voltage as a function of time. For purposes of discussion, it will be assumed that the waveform 100 is generated by the scanning transducer 22. The transducer is fired at time t₀. A first reflection occurs at a time t₁ with and amplitude 104. The time interval 101 between to and t₁ is defined as the travel time, and is a function of the impedance of the borehole fluid and the distance between the face of the transducer 22 and the inner surface of the borehole casing 12 (see FIG. 1). The amplitude 104 of the first reflection is a function of casing corrosion. The frequency of the reflected waveform in the intermediate time interval 106 is a function of casing thickness. The amplitude and rate of decay or “ring down” of the reflected waveform in the time interval 108 is a function of bonding between the casing 12 and the cement 14, and its value is inversely proportional to the acoustic impedance of the cement (see FIG. 1). Measures of travel time, amplitude of first reflection, frequency and ring down are processed to yield multiple parameters of interest as disclosed in detail as follows.

As stated above, the responses of the scanning and monitoring transducers are of the form of the waveform 100. Both scanning transducer and reference transducer responses are processed using essentially the same algorithms preferably in data processor 84 or the surface processor 91. In view of this, the following nomenclature is used in developing data processing algorithms:

x=the depth of the tool 10 in the borehole;

A(x)=the area under the ring down portion time interval 108 of the reflected waveform measured at depth x;

AMPF(x)=the amplitude 104 of the first arrival measured at depth x;

TT(x)=the travel time 101 measured at depth x

TTC(x)=the travel time measured in the first chamber 61 of the reference transducer assembly 20 (see FIG. 5) at depth x;

ACAL=the area under the ring down portion time interval 108 of the reflected waveform with the tool in “free pipe” or casing surrounded only by fluid;

AMPFC=the amplitude 104 of the first arrival measured in free pipe;

RBASE=the radius of the scanning head 20 (see FIG. 1); and

L=the length 76 of the first chamber 61 of the reference transducer assembly 20 (see FIG. 5).

The following are preferred predetermined relationships for determining parameters of interest and corrections for measured parameters of interest. It should be understood that alternate predetermined relationships can be developed by one skilled in the art.

The slowness FSLOW(x) of the borehole fluid at depth x is
FSLOW(x)=TTC(x)/L (1)
The thickness of the casing THICK is
THICK=CSIZ−((TT(x)/FSLOW(x))+(2RBASE)) (2)
where CSIZ is nominal casing size manually entered preferably into the data processor 84 prior to or during logging. An alternate method for measuring THICK will be disclosed in a subsequent section. AN(x) is defined by the relationship
AN(x)=A(x)/AMPF(x) (3)
with the corresponding value ACAL(x) in free pipe being
ACALN(x)=ACAL(x)/AMPFC(x) (4)
The quantity ARATIO(x) is a casing-cement bonding relationship and is defined as
ARATIO(x)=AN(x)/ACALN(x). (5)
It is noted that values of ACALN and AMPFC can be measured in free pipe conditions prior to logging, and these values can be used at each depth calculations. Changes in borehole conditions and systematic variations in equipment (such as transducer response drift) can, however, adversely affect subsequent calculations using these “constant” free pipe calibration parameters. The reference transducer assembly 20 allows these parameters to be measured and monitored as a function of depth (as previously discussed) therefore minimizing these potential sources of error in calculating parameters of interest.

Cement acoustic impedance Z(x) of the cement behind casing, from which a map of cement distribution as a function of depth is generated, is given by the relationship
Z(x)=a+(b+(c*THICK))*ln(ARATIO(x)) (6)
where a, b and c are predetermined constants and other terms on the right hand side of equation (6) are determined, as disclosed above, from parameters measured by the tool. The inside diameter ID(x) or “caliper” of the casing is given by
ID(x)=((TT(x)/FSLOW(x))+(2*RBASE)) (7)
Fractional casing corrosion COR(x), or fractional loss of metal, is given by the relationship
COR(x)=AMPF(x)/AMPFC(x) (8)

To summarize, casing-cement bonding, cement distribution behind casing, casing corrosion as indicated by loss of casing material, and casing inside diameter can be determined by processing and combining responses of the scanning and reference transducers. All determined parameters of interest are measured circumferentially around the borehole and as a function of depth within the borehole thereby forming two dimensional logs or “maps” of these parameters.

As mentioned above, nominal casing thickness CSIZ can be manually entered preferably into the data processor 84 prior to or during logging in order to determine THICK. Alternately, THICK can be determined as a function of depth from the response of the scanning transducer, and corrected for any adverse changes in borehole conditions and equipment drift using the response of the reference transducer assembly.

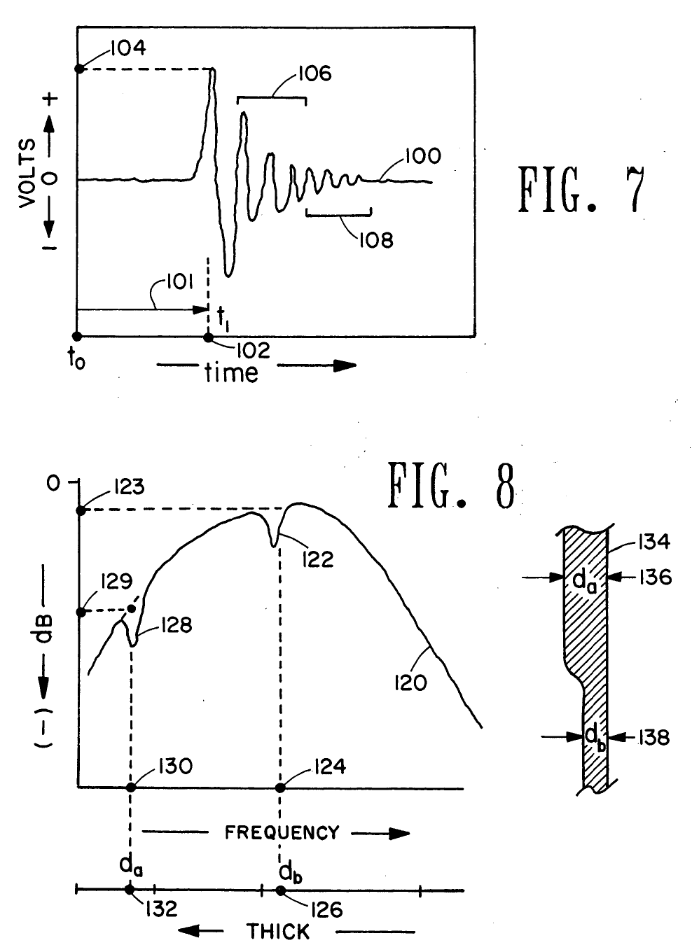

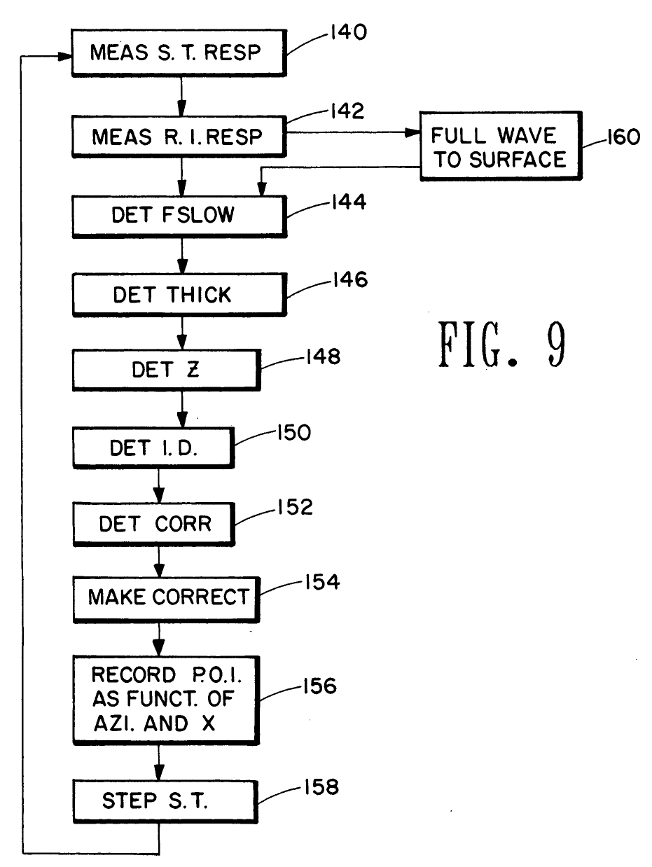

FIG. 8 depicts a curve 120 showing intensity of scanning transducer response as a function of frequency in the intermediate time interval 106 of the full wave response (see FIG. 7). As mentioned previously, frequency in this region is a function of casing thickness. Casing thickness THICK is shown as a second abscissa plot in FIG. 7. The functional relationship between frequency and THICK is obtained when the Ultrasonic Cement Scanner logging system is calibrated. Excursions in the curve 120 represent a casing of a given thickness. The insert to the right in FIG. 8 is a cross section of a hypothetical casing 134 of two thicknesses. The excursion 122 at a frequency 124 and at intensity 123 represents the thinner casing region of thickness d_{b} shown at 138. The excursion 128 at a lower frequency 130 and at lower intensity 129 represents the thicker casing region of thickness dₐ shown at 136. Curves of the form of 120 are generated from the full wave scanning transducer response preferably within the data processor 84. The curve is mathematically examined for excursions, and any detected excursion is related mathematically to casing thickness, THICK, as shown conceptually with the graphic illustrations in FIG. 7.

To summarize, the casing thickness THICK can be determined using equation (2) and the parameter CSIZ, which is nominal casing size that is manually entered preferably into the data processor 84. Alternately, THICK can be computed solely from the response of the scanning transducer 22 using the methodology set forth in the discussion of FIG. 8.

Logging Data Processing

As mentioned previously, various steps of data processing for the scanning and reference transducer can occur either within the downhole tool 10 in data processor 84 or within the surface processor 91. Since the full wave responses from the scanning and reference transducers are data intensive, it is desirable to process as much data as practical downhole and transmits computed parameters of interest uphole over the telemetry system 89. If substantial data processing is performed downhole, data transmission requirements are reduced to a level where logging equipment using single conductor cable can be used to operate the Ultrasonic Cement Scanner logging system. This yields a significant operational and economic advantage over logging equipment comprising multiconductor logging cable. It is preferred that all fluid velocity measurements and corrections be made down hole in real time. Other processing computations and corrections can be made as operational conditions and data band with restrictions dictate.

It is preferred that full waveforms be periodically transmitted, at selected azimuthal positions, to the surface for monitoring and additional processing. These transmissions can comprise full waveform response of the scanning transducer, full wave form of the reference transducer, or full wave forms from both of these transducers. The preferred selected azimuthal positions for transmission of these full waveforms is an azimuthal position in each quadrant swept by the scanning transducer head 20. As an example, selected azimuthal positions can be at 45, 135, 225 and 315 degrees measured with respect to a reference azimuthal position that is defined as “head zero”.

FIG. 9 is a flow chart of data processing methodology discussed in detail in previous sections of this disclosure. It should be understood that the order in which certain functions are performed can be varied without affecting the end results, namely the computation of borehole parameters of interest.

Referring to FIG. 9, the operation of the system is initiated using an azimuthal reference point which is preferably identified with a digital word designating “head zero” orientation. The full wave response of the scanning transducer is measured at 140, and the corresponding full waveform response of the reference transducer is measured at 142. As mentioned above, full waveform scanning transducer responses are periodically transmitted to the surface at 160. FSLOW is computed at 144 using equation (1). THICK is determined at 146 using one of the two previously discussed methods. Z, the acoustic impedance of the cement, is determined at 148 using equation (6) along with equations (3), (4), and (5). Casing ID is determined at 150 using equation (7). Casing corrosion is determined at 152 using equation (8). All of the previously discussed parametric corrections (variations in borehole fluid acoustic impedance and systematic tool variations) are made, as required, at 154. All parameters of interest, whether computed downhole or at the surface, are recorded as a function of borehole azimuth and depth x thereby forming one or more two-dimensional logs 97 (see FIG. 1). The scanning transducer is azimuthally stepped at 158, and the sequence beginning at 140 is repeated.

It is once again noted that full waveform data processing from both the scanning transducer and reference transducer is performed by the same software, whether within the data processor 84 or the surface processor 97. Any systematic variations are reflected in the processed reference trance data, and these variations can be used to correct the scanning transducer response for systematic variations.

While the foregoing disclosure is directed toward the preferred embodiments of the invention, the scope of the invention is defined by the claims, which follow.

What is claimed is:

1. A tool for measuring a parameter of a borehole, the tool comprising:
(a) a scanning head that rotates a scanning transducer assembly radially within said borehole;
(b) a mechanical subassembly for rotating said scanning head;
(c) a reference transducer assembly comprising
(i) a reference transducer,
(ii) a first chamber,
(iii) a second chamber, and
(iv) a plate separating said first chamber from said second chamber; and
(d) a processor for recording and processing full wave acoustic responses of said scanning transducer and said reference transducer; wherein
(e) a measure of said parameter
(i) is obtained in said processor from said response of said scanning transducer, and
(ii) said measure is corrected for variations in acoustic impedance of fluid filling said borehole and for systematic variations in said scanning transducer response by using said response of said reference transducer.

2. The tool of claim 1 wherein:
(a) said borehole is lined with a tubular;
(b) acoustic slowness of fluid filling said tubular is determined from travel time in said first chamber of acoustic energy emitted by said reference transducer;
(c) said second chamber allows free pipe response of said tool to be determined with said reference transducer while said tool is within said borehole; and
(d) said acoustic slowness of fluid and said free pipe response are used to correct said measure of said parameter for said variations in acoustic impedance of fluid filling said borehole and for said systematic variations in said scanning transducer response.

3. The tool of claim 2 wherein said parameter of interest is cement distribution within an annulus defined by an outer surface of said tubular and a wall of said borehole.

4. A method for measuring a parameter of a borehole, the method comprising:
(a) rotating radially within said borehole a scanning transducer;
(b) providing a reference transducer assembly comprising
(i) a reference transducer,
(ii) a first chamber,
(iii) a second chamber, and
(iv) a plate separating said first chamber from said second chamber;
(c) recording and processing full wave acoustic responses of said scanning transducer and said reference transducer; and
(d) combining said full wave acoustic responses of said scanning transducer and said reference transducer to obtain a measure of said parameter; wherein
(e) said measure is corrected for variations in acoustic impedance of fluid filling said borehole and for systematic variations in said scanning transducer response by using said response of said reference transducer.

5. The method of claim 4 comprising the additional steps of:
(a) determining, while said tool is within said borehole, acoustic slowness of fluid in a tubular disposed within said borehole from travel time in said first chamber of acoustic energy emitted by said reference transducer;
(b) determining, while said tool is within said borehole, free pipe response of said tool from response of said reference transducer interacting with said second chamber; and
(c) using said acoustic slowness of fluid and said free pipe response to correct said measure of said parameter for said variations in acoustic impedance of said fluid and for said systematic variations in said scanning transducer response.

6. The method of claim 5 wherein said parameter of interest is cement distribution within an annulus defined by an outer surface of said tubular and a wall of said borehole.

7. The method of claim 5 comprising the additional steps of:
(a) disposing said scanning transducer and said reference transducer in a tool;
(b) conveying said tool within said borehole with a wireline; and
(c) correcting said measure of said parameter for said variations in acoustic impedance of said fluid and for systematic variations in said scanning transducer response in a processor disposed within said tool.

8. A tool for measuring a parameter of interest within a borehole, the tool comprising:
(a) a scanning head that rotates a scanning transducer assembly radially within said borehole;
(b) a mechanical subassembly for rotating said scanning head; and
(c) a centralizer subassembly which positions said scanning head essentially in the center of said borehole, and comprises
(i) a mandrel,
(ii) a plurality of centralizer arm sets,
(iii) springs which urge said centralizer arm sets against a wall of said borehole within a given operating range, and
(iv) an adjustment nut and mandrel shaft assembly cooperating with said plurality of centralizer arm sets; wherein
(d) said adjustment nut can be rotated to vary said operating range of said centralizer subassembly; and
(e) said parameter of interest is determined from a full wave response of said scanning transducer.

9. The tool of claim 8 wherein:
(a) each said centralizer arm set comprises two centralizer arms, wherein each centralizer arm has a slider end and a roller end;
(b) a slider assembly is affixed to said slider end of each centralizer arm, and said two centralizer arms comprising said centralizer arm set are pivotally attached at said roller ends;
(c) a first end of a leaf spring is affixed to each said slider assembly and a second end of said leaf spring contacts said centralizer arm attached to that slider assembly; and
(d) for each said centralizer arm set,
(i) axial movement of one said slider assembly along said mandrel shaft assembly is limited by a shoulder on said adjustment nut, and
(ii) said second slider assembly moves axially along said mandrel shaft assembly, by the force of said leaf springs, as required to maintain contact between said centralizer arm set and a wall of said borehole.

10. The tool of claim 8 comprising six centralizer arm sets disposed at essentially equal radial spacings on said mandrel.

11. The tool of claim 8 further comprising:
(a) a reference transducer assembly comprising
(i) a reference transducer,
(ii) a first chamber,
(iii) a second chamber, and
(iv) a plate separating said first chamber from said second chamber; and
(b) a processor for recording and processing full wave acoustic responses of said scanning transducer and said reference transducer; wherein
(c) a measure of said parameter of interest
(i) is obtained in said processor from said response of said scanning transducer, and
(ii) said measure is corrected for variations in acoustic impedance of fluid in said borehole and for systematic variations in said scanning transducer response using said response of said monitor transducer.

12. The tool of claim 11 wherein:
(a) said borehole is lined with a tubular;
(b) acoustic slowness of fluid filling said tubular is determined from the travel time in said first chamber of acoustic energy emitted by said reference transducer;
(c) said second chamber allows free pipe response of said tool to be determined with said reference transducer while said tool is within said borehole; and
(d) said acoustic slowness of fluid and said free pipe response are used to correct said measure of said parameter for said variations in fluid filling said borehole and for said systematic variations in scanning transducer response.

13. The tool of claim 12 wherein said parameter of interest is cement distribution within an annulus defined by an outer surface of said tubular and said wall of said borehole.

14. A method for measuring a parameter of interest within a borehole, the method comprising:
(a) rotating a scanning transducer assembly radially within said borehole;
(b) providing a centralizer subassembly which positions said scanning transducer essentially in the center of said borehole, and comprises
(i) a mandrel,
(ii) a plurality of centralizer arm sets,
(iii) springs which urge said centralizer arm sets against a wall of said borehole within a given operating range, and
(iv) an adjustment nut and shaft assembly;
(c) rotating said adjustment nut to vary said operating range of said centralizer subassembly; and
(d) determining said parameter of interest from a full wave response of said scanning transducer.

15. The method of claim 14 comprising the additional steps of:
(a) disposing said scanning transducer and said mandrel within a tool; and
(b) disposing six centralizer arm sets at essentially equal radial spacings on said mandrel.

16. The method of claim 15 further comprising the additional steps of:
(a) disposing a reference transducer within said tool, wherein said reference transducer assembly comprises
(i) a reference transducer,
(ii) a first chamber,
(iii) a second chamber, and
(iv) a plate separating said first chamber from said second chamber;
(b) obtaining a measure of said parameter of interest from a full wave response said of said scanning transducer; and
(c) correcting said measure
(i) for variations in acoustic impedance of fluid using said response measured by said reference transducer in said first chamber, and
(ii) for systematic variations in said scanning transducer response using a full wave response measured by said monitor transducer in said second chamber.

17. The method of claim 16 wherein:
(a) said borehole is lined with a tubular;
(b) acoustic slowness of fluid in said tubular is determined from the travel time in said first chamber of acoustic energy emitted by said reference transducer while said tool is within said borehole;
(c) said second chamber allows free pipe response of said tool to be determined with said reference transducer while said tool is within said borehole; and
(d) said acoustic slowness of fluid and said free pipe response are used to correct said measure of said parameter for said variations acoustic impedance of said fluid and for said systematic variations in said scanning transducer response.

18. The method of claim 17 wherein said parameter of interest is cement distribution within an annulus defined by an outer surface of said tubular and a wall of said borehole.

19. The method of claim 15 wherein said tool is conveyed along said borehole with a wireline.

20. A tool for measuring a parameter of interest of a borehole, the tool comprising:
(a) a scanning head that rotates a scanning transducer radially within said borehole, wherein said scanning transducer comprises a piezoelectric crystal disposed on a backing material, and wherein
(i) said backing material comprises a large density material evenly dispersed in an elastic material, and
(ii) composite density of said backing material is in the range of 10 grams per cubic centimeter (gm/cm³) to 19 gm/cm³ thereby matching acoustic impedance of said backing material to acoustic impedance of said piezoelectric crystal; and
(b) a mechanical subassembly for rotating said scanning head; wherein
(c) said parameter of interest is obtained from a full wave response of said scanning transducer.

21. The tool of claim 20 further comprising:
(a) a centralizer subassembly which positions said scanning head essentially in the center of said borehole, and comprises
(i) a mandrel,
(ii) a plurality of centralizer arm sets,
(iii) springs which urge said centralizer arm sets against a wall of said borehole within a given operating range, and
(iv) an adjustment nut and mandrel shaft assembly cooperating with said plurality of centralizer arm sets, wherein said adjustment nut is rotated to vary an operating range of said centralizer subassembly.

22. The tool of 21 further comprising:
(a) a reference transducer assembly comprising
(i) a reference transducer,
(ii) a first chamber,
(iii) a second chamber, and
(iv) a plate separating said first chamber from said second chamber; and
(b) a processor for recording and processing full wave acoustic responses of said scanning transducer and said reference transducer; wherein
(c) a measure of said parameter of interest
(i) is obtained in said processor from said response of said scanning transducer, and
(ii) said measure is corrected for variations in acoustic impedance of fluid within said borehole and for systematic variations in said scanning transducer response using said response of said monitor transducer.

23. The tool of claim 22 wherein:
(a) said borehole is lined with a tubular;
(b) acoustic slowness of fluid filling said tubular is determined, with said tool in said borehole, from the travel time in said first chamber of acoustic energy emitted by said reference transducer;
(c) free pipe response of said tool is determined, with said tool in said borehole, from a full wave response of said reference transducer in said second chamber; and
(d) said acoustic slowness of fluid and said free pipe response are used to correct said measure of said parameter for said variations in acoustic impedance of said fluid and for said systematic variations in scanning transducer response.

24. The tool of claim 23 wherein said parameter of interest is cement distribution within an annulus defined by an outer surface of said tubular and a wall of said borehole.

25. A method for measuring a parameter of interest in a borehole, the method comprising:
(a) rotating a scanning transducer radially within said borehole, wherein said scanning transducer comprises a piezoelectric crystal disposed on a backing material; and
(b) fabricating said backing material with a large density material evenly dispersed in an elastic material; wherein composite density of said backing material is in the range of 10 grams per cubic centimeter (gm/cm³) to 19 gm/cm³ thereby matching acoustic impedance of said backing material to acoustic impedance of said piezoelectric crystal; and
(c) obtaining said parameter of interest from a full wave response of said scanning transducer.

26. The method of claim 25 further comprising the steps of:
(a) positioning said scanning transducer essentially in the center of said borehole with a centralizer subassembly, wherein said centralizer assembly comprises
(i) a mandrel,
(ii) a plurality of centralizer arm sets,
(iii) springs which urge said centralizer arm sets against a wall of said borehole within a given operating range, and
(iv) an adjustment nut and mandrel shaft assembly cooperating with said plurality of centralizer arm sets, wherein said adjustment nut is rotated to vary an operating range of said centralizer subassembly.

27. The method of 25 further comprising the steps of:
(a) providing a reference transducer assembly comprising
(i) a reference transducer,
(ii) a first chamber,
(iii) a second chamber, and
(iv) a plate separating said first chamber from said second chamber;
(b) determining acoustic slowness of fluid in said borehole, with said tool in said borehole, from the travel time in said first chamber of acoustic energy emitted by said reference transducer;
(c) determining free pipe response of said tool, with said tool in said borehole, from a full wave response of said reference transducer in said second chamber with said tool in said borehole; and
(d) using said acoustic slowness and said free pipe response to correct said measure of said parameter for said variations in acoustic impedance of said fluid and for said systematic variations in scanning transducer response.

28. The method of claim 25 wherein said parameter of interest is cement distribution within an annulus defined by an outer surface of tubular lining said borehole and a wall of said borehole.

29. The method of claim 25 comprising the additional steps of:
(a) disposing said scanning transducer within a tool; and
(b) conveying said tool along said borehole with a wireline.

30. A logging system for measuring a parameter of environs of a borehole, the system comprising:
(a) a tool;
(b) a conveyance means; and
(c) a data conduit connecting said tool and said conveyance means; wherein
(d) said tool comprises
(i) a scanning head that rotates a scanning transducer assembly radially within said borehole, wherein
said scanning transducer assembly comprises a piezoelectric crystal disposed upon a backing material fabricated with a large density material evenly dispersed in an elastic material, and
composite density of said backing material is in the range of 10 gm/cm³ to 19 gm/cm³ thereby matching acoustic impedance of said backing material to acoustic impedance of said piezoelectric crystal,
(ii) a mechanical subassembly comprising a motor for rotating said scanning head,
(iii) a reference transducer assembly comprising a reference transducer, a first chamber, a second chamber, and a plate separating said first chamber from said second chamber,
(iv) a centralizer subassembly which positions said tool essentially in the center of said borehole and comprises an adjustment nut and mandrel shaft assembly, wherein said adjustment nut can be rotated to vary the operating range of said centralizer subassembly, and
(iv) an electronics assembly comprising a processor in which
said measure of said parameter is determined from a full wave acoustic response of said scanning transducer assembly, and
said measure of said parameter is corrected for variations in acoustic impedance of borehole fluid using response of said reference transducer in said first chamber, and corrected for systematic variations using response of said reference transducer in said second chamber.

31. The logging system of claim 30 wherein said processor means comprises:
(a) a data processor in which said measure of said parameter and said correction of said measure are determined using predetermined relationships; and
(b) a control processor that cooperates with said motor and said data processor and a clock to
(i) rotate said scanning head,
(ii) sequentially fire said scanning transducer, and
(iii) receive said response of said scanning transducer, wherein
(iv) said response is free from interference from a previous scanning transducer firing.

32. The logging system of claim 31 further comprising:
(a) an up hole telemetry element operationally connected to said tool at an up hole end of said data conduit; and
(b) a down hole telemetry element
(i) disposed within said electronics subassembly,
(ii) operationally connected to a down hole end of said data conduit, and
(iii) cooperating with said data processor; wherein
(c) said measure of said parameter is telemetered via said downhole telemetry element over said data conduit to said up hole telemetry element.

33. The logging system of claim 32 further comprising a surface processor cooperating with said up hole telemetry element, wherein
(a) said full wave acoustic response from said scanning transducer assembly and a full wave response of said reference transducer assembly are telemetered via said down hole telemetry element over said data conduit to said surface processor cooperating with said up hole telemetry element; and
(b) said measure of said parameter and said correction of said measure are determined using a predetermined relationship in said surface processor.

34. The logging system of claim 32 wherein said full wave response of said scanning transducer at one or more selected azimuthal positions is telemetered via said downhole telemetry element over said data conduit to said up hole telemetry element.

35. The logging system of claim 30 wherein:
(a) said borehole is lined with a casing;
(b) acoustic slowness of fluid within said casing is determined, with said tool within said casing, from the travel time in said first chamber of acoustic energy emitted by said reference transducer;
(c) free pipe response of said tool is determined, with said tool is within said casing, from full wave response in said second chamber of said reference transducer; and
(d) said acoustic slowness of fluid and said free pipe response are used to correct said measure of said parameter for said variations in acoustic impedance of fluid within said borehole and for said systematic variations in scanning transducer response.

36. The logging system of claim 35 wherein said full wave responses of said scanning transducer and said monitor transducer comprise the elements:
(a) a first reflection;
(b) reflections occurring in an intermediate time interval following said first reflection; and
(c) a ring down section.

37. The logging system of 36 wherein casing corrosion is determined from amplitude of said first reflection using a predetermined casing corrosion relationship.

38. The logging system of claim 36 wherein bonding between the outer surface of said casing and material filling an annulus defined by said outer surface and a wall of said borehole is determined from said ring down section using a predetermined casing-cement bonding relationship.

39. The logging system of claim 36 wherein thickness of said casing is determined from frequency of reflected acoustic energy said intermediate region using a predetermined casing thickness relationship.

40. The logging system of claim 36 wherein distribution of cement in an annulus defined by an outer surface of said casing and a wall of said borehole is determined from frequency in said intermediate region and from said ring down section using a predetermined cement acoustic impedance relationship.

41. The logging system of claim 30 wherein said conveyance means comprises a logging system draw works.

42. The logging system of claim 41 wherein said data conduit comprises a multi conductor logging cable.

43. The logging system of claim 41 wherein said data conduit comprises a single conductor logging cable.

44. A method for measuring a parameter of environs of a borehole, the method comprising:
(a) providing a tool;
(b) operationally connecting said tool to a conveyance means by means of a data conduit; and
(c) conveying said tool along said borehole via said conveyance means and data conduit to measure said parameter as a function of depth within said borehole; wherein
(d) said tool comprises
(i) a scanning head that rotates a scanning transducer assembly radially within said borehole, wherein
said scanning transducer assembly comprises a piezoelectric crystal disposed upon a backing material fabricated with a large density material evenly dispersed in an elastic material, and
a composite density of said backing material is in the range of 10 gm/cm³ to 19 gm/cm³ thereby matching acoustic impedance of said backing material to acoustic impedance of said piezoelectric crystal,
(ii) a mechanical subassembly comprising a motor for rotating said scanning head,
(iii) a reference transducer assembly comprising a reference transducer, a first chamber, a second chamber, and a plate separating said first chamber from said second chamber,
(iv) a centralizer subassembly which positions said tool essentially in the center of said borehole and comprises an adjustment nut and mandrel shaft assembly, wherein said adjustment nut can be rotated to vary an operating range of said centralizer subassembly, and
(iv) an electronics assembly comprising a processor means in which
said measure of said parameter is determined from a full wave acoustic response of said scanning transducer assembly, and
said measure of said parameter is corrected for variations in acoustic impedance of borehole fluid using response of said reference transducer in said first chamber, and corrected for systematic variations using response of said reference transducer in said second chamber.

45. The method of claim 44 comprising the additional steps of:
(a) determining, in a data processor, said measure of said parameter and said correction of said measure using predetermined relationships; and
(b) with a control processor which cooperates with said motor and said data processor and a clock
(i) rotating said scanning head,
(ii) sequentially firing said scanning transducer, and
(iii) receiving said response of said scanning transducer, wherein
(iv) said response is free from interference from a previous scanning transducer firing.

46. The method of claim 45 comprising the additional steps of:
(a) providing an up hole telemetry element operationally connected to said tool at an up hole end of said data conduit; and
(b) providing a down hole telemetry element
(i) disposed within said electronics subassembly,
(ii) operationally connected to a down hole end of said data conduit, and
(iii) cooperating with said data processor; wherein
(c) said measure of said parameter is telemetered via said downhole telemetry element over said data conduit to said up hole telemetry element.

47. The method of claim 46 further comprising the steps of
(a) providing a surface processor cooperating with said up hole telemetry element;
(b) telemetering said full wave acoustic response from said scanning transducer assembly and a full wave response of said reference transducer assembly via said down hole telemetry element and over said data conduit to said surface processor through said up hole telemetry element; and
(c) determining said measure of said parameter and said correction of said measure using a predetermined relationship in said surface processor.

48. The method of claim 45 comprising the additional step of telemetering said full wave response of said scanning transducer at one or more selected azimuthal positions via said downhole telemetry element over said data conduit to said up hole telemetry element.

49. The method of claim 44 comprising the additional steps of determining, with said borehole lined with casing and with said tool within said casing:
(a) acoustic slowness of fluid filling said casing from the travel time in said first chamber of acoustic energy emitted by said reference transducer;
(b) free pipe response of said tool from full wave response of said reference transducer in said second chamber; and
(d) correction of said measurement of said parameter, using said acoustic slowness of fluid and said free pipe response, for said variations in acoustic impedance of borehole fluid and for said systematic variations.

50. The method of claim 49 wherein said full wave responses of said scanning transducer and said monitor transducer comprise the elements:
(a) a first reflection;
(b) reflections occurring in an intermediate time interval following said first reflection; and
(c) a ring down section.

51. The method of claim 50 comprising the additional step of determining casing corrosion from amplitude of said first reflection using a predetermined casing corrosion relationship.

52. The method of claim 50 comprising the additional step of determining bonding between the outer surface of said casing and material filling an annulus defined by said outer surface and a wall of said borehole from said ring down section using a predetermined casing-cement bonding relationship.

53. The method of claim 50 comprising the additional step of determining thickness of said casing from frequency of reflected acoustic energy said intermediate region using a predetermined casing thickness relationship.

54. The method of claim 50 comprising the additional step of determining distribution of cement in an annulus defined by an outer surface of said casing and a wall of said borehole from frequency in said intermediate region and from said ring down section using a predetermined cement acoustic impedance relationship.

55. The method of claim 44 wherein said conveyance means comprises a logging system draw works.

56. The method of claim 55 wherein said data conduit comprises a multi conductor logging cable.

57. The method of claim 55 wherein said data conduit comprises a single conductor logging cable.
